(19) United States
(12) Patent Application Publication
(10) Pub. No.: US 2024/0266507 A1
(43) Pub. Date: Aug. 8, 2024

(54) ANODE FOR LITHIUM SECONDARY BATTERY AND LITHIUM SECONDARY BATTERY INCLUDING THE SAME

(71) Applicant: SK ON CO., LTD., Seoul (KR)

(72) Inventors: Hyun Joong JANG, Daejeon (KR); Jae Ram KIM, Daejeon (KR); Ki Joo EOM, Daejeon (KR); Yong Seok LEE, Daejeon (KR)

(21) Appl. No.: 18/540,880

(22) Filed: Dec. 15, 2023

(30) Foreign Application Priority Data
Feb. 8, 2023 (KR) 10-2023-0016589

(51) Int. Cl. H01M 4/36; H01M 4/133; H01M 4/48; H01M 4/587; H01M 4/62; H01M 4/02

(52) U.S. Cl. CPC H01M 4/366; H01M 4/133; H01M 4/364; H01M 4/483; H01M 4/587; H01M 4/622; H01M 4/625; H01M 2004/021; H01M 2004/027

(57) ABSTRACT

According to an embodiment, a lithium secondary battery substantially suppressing volume expansion of a silicon-based active material and having excellent characteristics such as capacity, lifespan, and the like is provided. An anode for the lithium secondary battery includes a current collector; a first anode mixture layer on at least one surface of the current collector; and a second anode mixture layer on the first anode mixture layer, wherein the first anode mixture layer and the second anode mixture layer include a carbon-based active material, respectively, the second anode mixture layer includes a silicon-based active material, and an upper and lower layer unit capacity ratio (R_{uc}) is 1.1 or more.

### CROSS-REFERENCE TO RELATED APPLICATION (S)

This patent document claims the priority and benefits of Korean Patent Application No. 10-2023-0016589 filed on Feb. 8, 2023, the disclosure of which is incorporated herein by reference in its entirety.

### TECHNICAL FIELD

The technology and implementations disclosed in this patent document generally relate to an anode for a lithium secondary battery, and a lithium secondary battery including the same.

### BACKGROUND

As interest in environmental issues has recently increased, research on an electric vehicle (EV) that may replace a fossil fuel-based vehicle, which is one of the main causes of air pollution, is actively underway. A lithium secondary battery having a high discharge voltage and output stability may be used as a power source for such an electric vehicle (EV). In this regard, as a need for a secondary battery having high energy density increases, development and research on a high-capacity anode for the battery are also actively underway.

### SUMMARY

The disclosed technology may be implemented in some embodiments to provide an anode for a lithium secondary battery having excellent lifespan characteristics.

The disclosed technology may be implemented in some embodiments to provide an anode for a lithium secondary battery having excellent quick charging performance.

The disclosed technology may be implemented in some embodiments to provide an anode for a high-capacity lithium secondary battery.

In some embodiments of the disclosed technology, an anode for a lithium secondary battery, includes a current collector; a first anode mixture layer on at least one surface of the current collector; and a second anode mixture layer on the first anode mixture layer, wherein the first anode mixture layer and the second anode mixture layer include a carbon-based active material, respectively, the second anode mixture layer includes a silicon-based active material, and, in the anode, an upper and lower layer unit capacity ratio (R_{uc}) according to Equation 1 is 1.1 or more:

$${R}_{uc} = {UC}_{2} / {UC}_{1} \qquad [ Equation 1 ]$$

In Equation 1, R_{uc} is an upper and lower layer unit capacity ratio, and UC₁ and UC₂ are unit capacity (UC) of each of the first and second anode mixture layers, respectively, according to Equation 2:

$$UC = ( {W}_{c} \times {C}_{c} ) + ( {W}_{s} \times {C}_{s} ) \qquad [ Equation 2 ]$$

In Equation 2, UC is a unit capacity (mAh/g) in each of the layers, W_{c} and Wₛ are an amount ratio of each of the carbon-based active material and the silicon-based active material in each of the layers, by weight, and C_{c} and Cₛ are a unit capacity (mAh/g) of each of the carbon-based active material and the silicon-based active material.

In the anode for a lithium secondary battery, an upper electrode capacity ratio (R_{ec}) according to Equation 3 may be less than 0.5:

$${R}_{ec} = {EC}_{2} / ( {EC}_{1} + {EC}_{2} ) \qquad [ Equation 3 ]$$

In Equation 3, R_{ec} is an upper electrode capacity ratio, and EC₁ and EC₂ are an electrode capacity (EC) of each of the first anode mixture layer and the second anode mixture layer according to Equation 4:

$$EC = UC \times {R}_{1 w} \qquad [ Equation 4 ]$$

In Equation 4, EC is an electrode capacity (mAh/g) of each of the layers, UC is a unit capacity (mAh/g) of each of the layers according to Equation 2, and R_{lw} is a loading weight (LW) ratio of each of the layers.

An amount of the silicon-based active material in the second anode mixture layer may be 10 wt % or more, based on a total weight of the second anode mixture layer.

The second anode mixture layer may further include a linear conductive material.

The linear conductive material may be any one selected from a single-walled carbon nanotube (SWCNT), a multi-walled carbon nanotube (MWCNT), and combinations thereof.

A loading weight (LW) ratio of the first anode mixture layer and the second anode mixture layer may be 1.1:1 to 5:1.

The first anode mixture layer and the second anode mixture layer may further include a binder and a thickener, respectively.

In the first anode mixture layer, an amount of the binder by weight may be higher than an amount of the thickener by weight.

In the second anode mixture layer, an amount of the binder by weight may be lower than an amount of the thickener by weight.

The binder may include a rubber-based compound.

The thickener may include a water-soluble polymer-based compound.

In some embodiments of the disclosed technology, a lithium secondary battery according to an embodiment may include the anode for a lithium secondary battery according to any one of the above-described embodiments.

### BRIEF DESCRIPTION OF DRAWINGS

Certain aspects, features, and advantages of the disclosed technology may be illustrated by the following detailed description with reference to the accompanying drawings.

FIG. 1 is a cross-sectional view schematically illustrating an anode structure for a lithium secondary battery according to a comparative example.

FIG. 2 is a cross-sectional view schematically illustrating an anode structure for a lithium secondary battery according to an embodiment.

FIG. 3 is a view illustrating a cross-section of an anode after performing 400 quick charge/discharge cycles on and disassembling secondary batteries of an inventive example and a comparative example, in order to compare whether lithium metal is deposited on a surface of the anode during quick charging.

### DETAILED DESCRIPTION

Features of the disclosed technology disclosed in this patent document may be described by example embodiments with reference to the accompanying drawings.

According to an embodiment, capacity of a secondary battery may be improved by applying a silicon-based active material having higher discharge capacity, relative to graphite, to an anode for the secondary battery. The silicon-based active material may have a higher volume expansion rate than the graphite, and as relatively large contraction/expansion are induced during a repeated charging/discharging process of the battery, delamination of an active material layer, an increase in internal resistance of an electrode, a side reaction with an electrolyte solution, a decrease in lifespan characteristics of the electrode, or the like may occur.

During quick charging (high C-rate charging) to shorten a charging time of the lithium secondary battery, gas may be generated in the battery or lithium metal may be precipitated on a surface of the anode. This may be because the surface of the anode acts as a bottleneck during the quick charging, and amounts of lithium ions moving from a cathode to the anode may become greater than amounts of lithium ions inserted into an anode active material. As a result, the lithium ions not inserted into the anode active material may be reduced to occur precipitation of lithium metal on the surface of the anode. The precipitated lithium metal may continuously cause a side reaction in the battery due to low electrochemical stability thereof, to reduce lifespan of the battery, and may further cause a short circuit in the battery to lose a function of the battery or occur a fire of the battery.

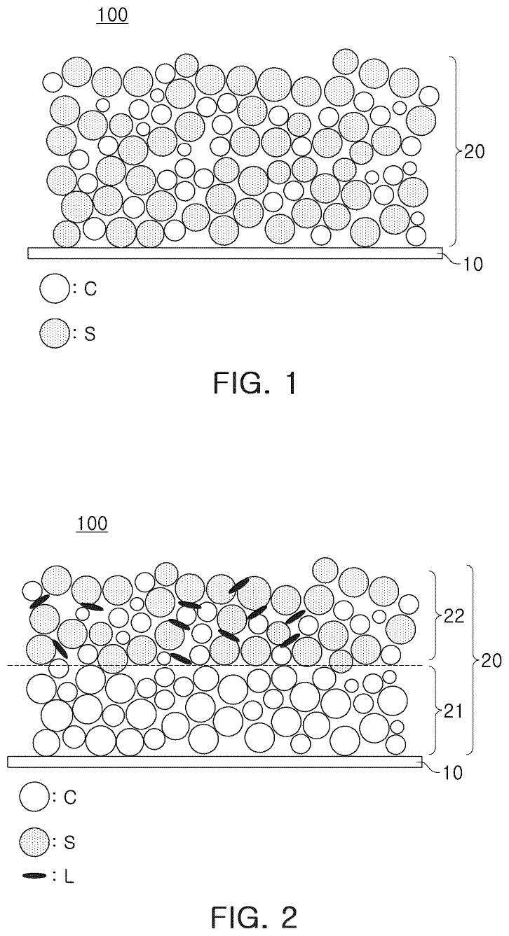

In an anode for a lithium secondary battery having a single-layer structure (see FIG. 1), silicon-based active materials included in an active material layer may be relatively uniformly included in lower and upper portions, based on a current collector. In this case, since amounts of the silicon-based active materials included in the lower portion (adjacent to the current collector), which may be relatively more affected by volume expansion of the silicon-based active materials, may be similar or identical to amounts of the silicon-based active materials included in the upper portion (adjacent to a surface of the anode), there may be difficulty in alleviating problems caused by the volume expansion of the silicon-based active materials. Additionally, in this case, there may be difficulty in increasing capacity of lithium ions that may be inserted from the surface of the anode into the active material layer during quick charging.

According to an embodiment of the present disclosure, the above-mentioned problems may be alleviated, and a high-capacity lithium secondary battery having excellent lifespan characteristics, quick charging characteristics, and the like may be provided. Hereinafter, implementation examples of the present disclosure will be described in more detail with reference to FIGS. 1 to 3.

FIG. 1 is a cross-sectional view schematically illustrating an anode structure for a lithium secondary battery according to a comparative example.

FIG. 2 is a cross-sectional view schematically illustrating an anode structure for a lithium secondary battery according to an embodiment.

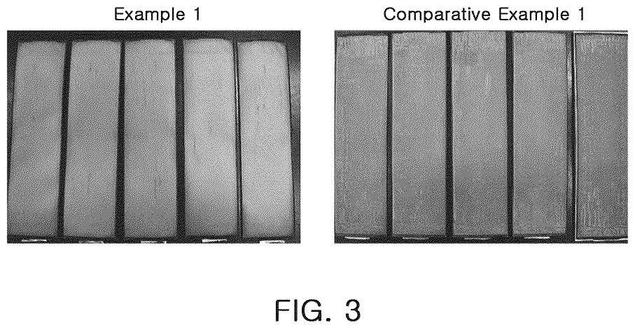

FIG. 3 is a view illustrating a cross-section of an anode after performing 400 quick charge/discharge cycles on and disassembling secondary batteries of an inventive example and a comparative example, in order to compare whether lithium metal is deposited on a surface of the anode during quick charging.

### Anode for Lithium Secondary Battery

An anode for a lithium secondary battery according to an embodiment may include a current collector 10; a first anode mixture layer 21 on at least one surface of the current collector; and a second anode mixture layer 22 on the first anode mixture layer, wherein the first anode mixture layer and the second anode mixture layer may include a carbon-based active material C, respectively, and the second anode mixture layer may include a silicon-based active material S.

The anode for a lithium secondary battery may include an anode mixture layer 20 on the at least one surface of the current collector 10, and the anode mixture layer 20 may include the first anode mixture layer 21 on the at least one surface of the current collector; and the second anode mixture layer 22 on the first anode mixture layer 21. Specifically, the first anode mixture layer (a lower layer) may be an active material layer on one surface adjacent to the current collector, and the second anode mixture layer (an upper layer) may be an active material layer disposed on the first anode mixture layer, relatively spaced from the current collector, and adjacent to a surface of the anode.

In the anode for a lithium secondary battery according to an embodiment, an amount of the silicon-based active material included in the first anode mixture layer (lower layer) may be different from an amount of the silicon-based active material included in the second anode mixture layer (upper layer).

For example, since the first anode mixture layer, the lower layer adjacent to the current collector, may not include the silicon-based active material, and only the second anode mixture layer, the upper layer adjacent to the surface of the anode, may include the silicon-based active material, effects (electrode detachment or the like) due to a high volume expansion rate of the silicon-based active material may be suppressed. In this case, since the second anode mixture layer (upper layer) adjacent to the surface of the anode has relatively high capacity characteristics, amounts of lithium ions that may be inserted from the surface of the anode into an active material layer during quick charging may increase. In addition, precipitation (plating) of the lithium metal on the surface of the anode due to quick charging may be effectively alleviated. In this regard, an upper and lower layer unit capacity ratio (R_{uc}) of the anode for a lithium secondary battery will be described in detail below.

The anode for a lithium secondary battery may have an upper and lower layer unit capacity ratio (R_{uc}) of 1.1 or more according to Equation 1:

$${R}_{uc} = {UC}_{2} / {UC}_{1} \qquad [ Equation 1 ]$$

In Equation 1, R_{uc} is an upper and lower layer unit capacity ratio, and UC₁ and UC₂ are unit capacity (UC) of each of the first and second anode mixture layers, respectively, according to Equation 2:

$$UC = ( {W}_{c} \times {C}_{c} ) + ( {W}_{s} \times {C}_{s} ) \qquad [ Equation 2 ]$$

In Equation 2, UC is a unit capacity (mAh/g) in each of the layers, W_{c} and Wₛ are an amount ratio of each of the carbon-based active material and the silicon-based active material in each of the layers, by weight, and C_{c} and Cₛ are a unit capacity (mAh/g) of each of the carbon-based active material and the silicon-based active material.

The upper and lower layer unit capacity ratio (R_{uc}) refers to a ratio between unit capacities (UC) of the anode mixture layers located in the upper and lower layers of the anode having a multilayer structure. Specifically, the R_{uc} may be a value obtained by dividing unit capacity (UC₂) of the second anode mixture layer (upper layer) by unit capacity (UC₁) of the first anode mixture layer (lower layer), and refers to a ratio of capacity of the upper layer relative to capacity of the lower layer, in each of the layers.

The unit capacity (UC) of each of the layers may be a capacity value that does not take into account a loading weight (LW) of each of the layers, which will be described later, and may be a value (mAh/g) representing a magnitude of capacity of each of the layers in the anode having a multilayer structure, by weight. For example, the unit capacity (UC) of each of the layers may be a capacity value determined depending on a type, an amount, or the like of an active material included in each of the layers, and may be unrelated to a weight of each of the layers coated on the current collector.

Therefore, when a relative amount of the silicon-based active material, which has high capacity characteristics, relative to the carbon-based active material, is larger in the second anode mixture layer (upper layer) than the first anode mixture layer (lower layer), the unit capacity (UC₂) of the second anode mixture layer may be higher than the unit capacity (UC₁) of the first anode mixture layer. For example, the upper and lower layer unit capacity ratio (R_{uc}), which is a value obtained by dividing the UC₂ by UC₁ according to Equation 1, may be greater than 1.

The R_{uc} may be 1.1 or more, 1.3 or more, or 1.5 or more, and may be 5 or less or 3 or less. When the R_{uc} value is too high, there may be difficulty in suppressing volume expansion because an amount of the silicon-based active material included in the upper layer relative to the lower layer is too high. Therefore, it may be desirable to adjust the R_{uc} value within the above-mentioned range.

The unit capacity (UC) for each of the layers may be calculated by measuring an amount ratio and a unit capacity value of each of the carbon-based active material and the silicon-based active material, included in each of the layers.

Specifically, the unit capacity (UC) of each of the layers may be calculated by adding the product of the amount ratio (W_{c}) in each of the layers and the unit capacity (C_{c}) of the carbon-based active material, and the product of the amount ratio (Wₛ) in each of the layers and the unit capacity (Cₛ) of the silicon-based active material. In this case, the amount ratio (W_{c}) in each of the layers of the carbon-based active material and the amount ratio (Wₛ) in each of the layers of the silicon-based active material may refer to ratio values calculated based on an amount (wt %) of each of the active materials included in the anode mixture layer as 1.

The unit capacity (C_{c}) of the carbon-based active material may be 200 to 500 mAh/g, or 300 to 400 mAh/g.

As the carbon-based active material, at least one carbon-based material selected from artificial graphite, natural graphite, amorphous hard carbon, low-crystalline soft carbon, carbon black, acetylene black, Ketjen black, Super P, graphene, and fibrous carbon may be used.

Specifically, natural graphite, artificial graphite, or a combination thereof may be used as the carbon-based active material. In general, the natural graphite may be known to have higher capacity characteristics than the artificial graphite, but they may be used in appropriate combination considering economic efficiency, structural stability, or the like.

The unit capacity (Cₛ) of the silicon-based active material may be 700 to 3000 mAh/g, or 1000 to 2000 mAh/g.

As the silicon-based active material, a silicon oxide-based active material (SiOₓ; 0<x<2), a silicon carbide-based active material (SiC), or a combination thereof may be used. In general, since the silicon carbide-based active material may have higher capacity characteristics than the silicon oxide-based active material, but may be also known to have relatively high volume expansion rate, they may be used in appropriate combination.

The unit capacity of the silicon oxide-based active material may be 1000 to 1500 mAh/g, and the unit capacity of the silicon carbide-based active material may be 1600 to 2000 mAh/g.

An anode for a lithium secondary battery according to an embodiment applies different loading weights (LW) to each of the first anode mixture layer and the second anode mixture layer, for example, having the above characteristics, to alleviate problems due to a difference in amount of the silicon-based active material of each of the layers. In this regard, an upper electrode capacity ratio (R_{ec}) of the anode for a lithium secondary battery will be described in detail below.

The anode for a lithium secondary battery may have an upper electrode capacity ratio (R_{ec}) of less than 0.5 according to Equation 3:

$${R}_{ec} = {EC}_{2} / ( {EC}_{1} + {EC}_{2} ) \qquad [ Equation 3 ]$$

In Equation 3, R_{ec} is an upper electrode capacity ratio, and EC₁ and EC₂ are an electrode capacity (EC) of each of the first anode mixture layer and the second anode mixture layer according to Equation 4:

$$EC = UC \times {R}_{1 w} \qquad [ Equation 4 ]$$

In Equation 4, EC is an electrode capacity (mAh/g) of each of the layers, UC is a unit capacity (mAh/g) of each of the layers according to Equation 2, and R_{lw} is a loading weight (LW) ratio of each of the layers.

The upper electrode capacity ratio (R_{ec}) refers to a capacity ratio occupied by the upper layer in the entire electrode capacity (EC) of the anode having a multilayer structure. Specifically, the entire electrode capacity of the anode may be a sum of the electrode capacity (EC₁) of the first anode mixture layer (lower layer) and the electrode capacity (EC₂) of the second anode mixture layer (upper layer). Therefore, the upper electrode capacity ratio (R_{ec}) may be a value obtained by dividing the electrode capacity (EC₂) of each of the layers of the second anode mixture layer by the entire electrode capacity (EC₁+EC₂) of the anode calculated as above.

The electrode capacity (EC) of each of the layers may be calculated considering both the unit capacity (UC) of each of the layers calculated according to Equation 2 and the loading weight (LW) ratio of each of the layers. Specifically, the electrode capacity (EC) for each of the layers may be the product of the unit capacity (UC) for each of the layers and the loading weight ratio (R_{lw}) for each of the layers according to Equation 4 above.

The unit capacity (UC) of each of the layers may be a value (mAh/g) representing a magnitude of capacity of each of the layers in the anode having a multilayer structure, by weight, may be capacity determined depending on a type, an amount, or the like of an active material included in each of the layers, and may be thus independent of a total weight of each of the layers. The electrode capacity (EC) of each of the layers may be a value that additionally considers a loading weight (LW) of each of the layers, for example, a weight of each of the layers coated on the current collector (mg/cm²) by area, and may be calculated by multiplying the unit capacity (UC) of each of the layers and the loading weight (LW) ratio (R_{lw}) of each of the layers a unit capacity (mAh/g) and a loading weight (mg/cm²) in each of the layers.

Therefore, even when a unit capacity value of each of the layers in the upper layer is relatively large, and when the loading weight ratio (R_{lw}) of each of the layers is small, the upper electrode capacity ratio (R_{ec}) value may become small, and vice versa.

An anode for a lithium secondary battery according to an embodiment may have an upper electrode capacity ratio (R_{ec}) of 0.45 or less or 0.4 or less, and 0.1 or more, 0.2 or more, or 0.3 or more. When the R_{ec} value is too high, an amount of the silicon-based active material based on the entire electrode may be excessive, making it difficult to alleviate volume expansion or the like therefrom. When the R_{ec} value is too small, there may be difficulty in securing high capacity characteristics due to insufficient amount of the silicon-based active material based on the entire electrode. Therefore, it may be desirable to adjust the R_{ec} value within the above-mentioned range.

An amount of the silicon-based active material in the second anode mixture layer may be 10 wt % or more based on the total weight of the second anode mixture layer. Specifically, an amount of the silicon-based active material in the second anode mixture layer may be 13 wt % or more or 17 wt % or more, and 30 wt % or less or 23 wt % or less, based on the total weight of the second anode mixture layer. Therefore, the amount ratio (Wₛ) in each of the layers of the silicon-based active material in the second anode mixture layer may be 0.13 or more or 0.17 or more, and may be 0.3 or less or 0.23 or less.

When an amount of the silicon-based active material in the second anode mixture layer is too small, there may be a limit to securing high capacity characteristics as an entire anode, and when an amount of the silicon-based active material in the second anode mixture layer is too large, problems such as a cracking phenomenon due to volume expansion, deterioration of life characteristics, or the like may occur. Therefore, when an amount of the silicon-based active material in the second anode mixture layer is controlled within the above-mentioned range, an anode having both high capacity, excellent lifespan characteristics, and the like at the same time may be provided.

An amount of the silicon-based active material in the first anode mixture layer may be less than 1 wt %, based on the total weight of the first anode mixture layer, and an amount of the silicon-based active material in the first anode mixture layer may be 0.01 wt % or more based on the total weight of the first anode mixture layer. In this case, the amount ratio (Wₛ) in each of the layers of the silicon-based active material in the first anode mixture layer may be less than 0.01, and the amount ratio (Wₛ) in each of the layers of the silicon-based active material in the first anode mixture layer may be 0.0001 or more. According to an embodiment, an amount of the silicon-based active material in the first anode mixture layer may be 0 wt %, based on the total weight of the first anode mixture layer. In this case, the amount ratio (Wₛ) in each of the layers of the silicon-based active material in the first anode mixture layer may be 0.

When an amount of the silicon-based active material in the first anode mixture layer is different from an amount of the second anode mixture layer, volume expansion rates of the layers may be different, which may cause problems such as peeling of the current collector layer, precipitation of lithium metal on the surface of the anode, or the like. In this regard, when an appropriate type of conductive material is included in the second anode mixture layer 22 including the silicon-based active material, such problems may be efficiently prevented. Specifically, the second anode mixture layer may further include a linear conductive material L.

The linear conductive material such as a carbon nanotube (CNT) or the like may suppress volume expansion of the silicon-based active material, but usage thereof may be limited due to relatively high cost thereof.

In an anode for a lithium secondary battery according to an embodiment, the second anode mixture layer, which may be an upper layer including a silicon-based active material, may include a linear conductive material to suppress volume expansion of the silicon-based active material and a decrease in conductivity of the active material. In some embodiments, the second anode mixture layer may include only the linear conductive material as a conductive material. Additionally, in some implementations, the first anode mixture layer may not include the linear conductive material. The second anode mixture layer including a silicon-based active material may further include only the linear conductive material as a conductive material, and the first anode mixture layer having a relatively small amount of the silicon-based active material or not including the silicon-based active material may not include the linear conductive material any more.

When conductive material-related characteristics of the first anode mixture layer and the second anode mixture layer are as described above, while increasing an amount of the linear conductive material included in the upper layer including the silicon-based active material, it is possible to decrease an amount of the linear conductive material as a whole of the electrode by reducing an amount of the linear conductive material included in the lower layer having a relatively low amount or a substantially no amount of the silicon-based active material. Therefore, while effectively preventing problems caused by volume expansion of the silicon-based active material, economic efficiency may also be secured by reducing an amount of the expensive linear conductive materials.

The linear conductive material may be a linear carbon-based conductive material. Specifically, the linear conductive material may be any one selected from a single-walled carbon nanotubes (SWCNT), a multi-walled carbon nanotube (MWCNT), and combinations thereof. The single-walled carbon nanotubes (SWCNT) may have superior performance, as compared to the multi-walled carbon nanotube (MWCNT), but considering relatively high cost thereof, may be mixed and used appropriately.

An amount of the conductive material in the first anode mixture layer may be 0.1 to 5 wt %, 0.3 to 3 wt %, or 0.5 to 1.5 wt %, based on the total weight of the first anode mixture layer. An amount of the conductive material in the second anode mixture layer may be 0.1 to 5 wt %, 0.3 to 3 wt %, or 0.5 to 1.5 wt, based on the total weight of the second anode mixture layer. When an amount of the conductive material in each of the anode mixture layers may be within the above-mentioned range, an effect of adding the conductive material may be efficiently obtained without deteriorating functions of other components, in addition to the active material.

A loading weight (LW) of the first anode mixture layer may be greater than a loading weight (LW) of the second anode mixture layer. Specifically, a loading weight (LW) ratio of the first anode mixture layer and the second anode mixture layer may be 1.1:1 to 5:1. More specifically, a loading weight (LW) ratio of the first anode mixture layer and the second anode mixture layer may be 1.5:1 to 4:1 or 2.5:1 to 3.5:1.

The loading weight (LW) of the first anode mixture layer and the loading weight (LW) of the second anode mixture layer means amounts of coating of each of the anode mixture layers formed on the current collector, expressed in units of weight per area (mg/cm²). In this case, the area may be based on an area of the current collector, and the weight may be based on weight of the entire anode mixture layers formed. A detailed description of the loading weight (LW) will be omitted since it overlaps the above description.

The loading weight (LW) of the first anode mixture layer may be 1 to 20 mg/cm², 3 to 15 mg/cm², or 5 to 10 mg/cm².

The loading weight (LW) of the second anode mixture layer may be 0.3 to 7 mg/cm², 1 to 5 mg/cm², or 2 to 4 mg/cm².

When the loading weight (LW) and its ratio of each of the first and second anode mixture layers are within the above-mentioned range, an amount in which the second anode mixture layer (upper layer) including the silicon-based active material and adjacent to the surface of the anode, and the first anode mixture layer (lower layer) adjacent to the current collector are coated may be highly adjusted within an appropriate range, to alleviate problems caused by volume expansion of the silicon-based active material, secure high capacity characteristics of the battery, and secure excellent quick charging performance.

The first anode mixture layer and the second anode mixture layer may further include a binder and a thickener, respectively.

The binder may be at least one rubber-based compound selected from the group consisting of a styrene-butadiene rubber (SBR), a fluorine-based rubber, an ethylene propylene rubber, a butyl acrylate rubber, a butadiene rubber, an isoprene rubber, an acrylonitrile rubber, an acrylic-based rubber, and a silane-based rubber. Specifically, the binder may include a styrene-butadiene rubber (SBR). In this case, adhesion between the current collector and the first anode mixture layer (lower layer) formed on one surface adjacent to the current collector may be further improved.

The thickener may include a water-soluble polymer-based compound. Specifically, the thickener may include at least one cellulose-based compound such as carboxymethylcellulose (CMC), hydroxypropylmethylcellulose, methylcellulose, or the like, or an alkali metal salt thereof. The alkali metal may include Na, K, or Li. More specifically, the thickener may include carboxymethylcellulose (CMC) or an alkali metal salt thereof. When the above-described type of thickener is included along with the binder in the anode mixture layer, viscosity may be further imparted to improve adhesion of the electrode.

In the first anode mixture layer, an amount of the binder by weight may be larger than an amount of the thickener by weight, and, in the second anode mixture layer, an amount of the binder by weight may be smaller than an amount of the thickener by weight. For example, an amount of the binder relative to the thickener may be adjusted to be relatively large in the lower layer, and an amount of the binder relative to the thickener may be adjusted to be relatively small in the upper layer.

A total amount of the binder and thickener in the first anode mixture layer may be 0.2 to 7.0 wt %, 1.0 to 5.0 wt %, or 3.0 to 4.0 wt %, based on the total weight of the first anode mixture layer.

Specifically, an amount of the binder may be 0.1 to 5.0 wt %, 0.7 to 3.3 wt %, or 2.0 to 2.5 wt %, based on the total weight of the first anode mixture layer. When an amount of the binder is too small, adhesion may decrease to occur detachment during a notching process, and when an amount of the binder is too large, electrical resistance may increase to deteriorate characteristics of the battery.

Specifically, an amount of the thickener may be 0.1 to 2.0 wt %, 0.3 to 1.7 wt %, 0.5 to 1.5 wt %, or 0.7 to 1.3 wt %, based on the total weight of the first anode mixture layer. When an amount of the thickener is too small, it may be difficult to secure adhesion between the active material layers, which may lead to occur scrap and partial detachment during a notching process. When an amount of the thickener is too large, electrical resistance may increase.

An amount ratio of the binder and the thickener in the first anode mixture layer may be 1:1 to 5:1 or 1.5:1 to 3:1.

A total amount of the binder and thickener in the second anode mixture layer may be 0.1 to 5 wt %, 0.5 to 4.0 wt %, or 1.0 to 3.0 wt %, based on the total weight of the second anode mixture layer.

Specifically, an amount of the thickener may be 0.07 to 3.5 wt %, 0.3 to 3.2 wt %, or 0.5 to 1.5 wt %, based on the total weight of the second anode mixture layer, and an amount of the binder may be 0.03 to 1.7 wt %, 0.15 to 1.6 wt %, or 0.5 to 0.7 wt %, based on the total weight of the second anode mixture layer.

An amount ratio of the binder and the thickener in the second anode mixture layer may be 1:0.1 to 1:1 or 1:0.6 to 1:0.9.

When specific amounts of the binder and thickener in the first anode mixture layer and the second anode mixture layer are as the above-mentioned description, an electrode having a multilayer structure may have excellent flexibility, adhesion, or the like, to substantially alleviate problems such as detachment of the electrode during a process, cracking or detachment of the electrode during a charge/discharge process, or the like.

The first anode mixture layer and the second anode mixture layer each include a carbon-based active material.

The carbon-based active material may be at least one carbon-based material selected from crystalline artificial graphite, crystalline natural graphite, amorphous hard carbon, low-crystalline soft carbon, carbon black, acetylene black, Ketjen black, Super P, graphene, and fibrous carbon.

The carbon-based active materials included in the first anode mixture layer and the second anode mixture layer may be the same or different from each other. The second anode mixture layer (upper layer) including the silicon-based active material may include artificial graphite having excellent resistance characteristics.

An amount of the carbon-based active material in the first anode mixture layer may be 85 to 100 wt % or 90 to 97 wt %, based on the total weight of the first anode mixture layer. Therefore, an amount ratio (W_{c}) of each of the layers of the carbon-based active material in the first anode mixture layer may be 0.85 to 1 or 0.9 to 0.97.

An amount of the carbon-based active material in the second anode mixture layer may be 50 to 100 wt % or 60 to 80 wt %, based on the total weight of the second anode mixture layer. Therefore, an amount ratio (W_{c}) of each of the layers of the carbon-based active material in the second anode mixture layer may be 0.5 to 1 or 0.6 to 0.8.

A method of manufacturing an anode for a secondary battery is not particularly limited, and may be performed by known methods. For example, a first anode slurry including a first solvent, a first carbon-based active material, a first binder, and a first thickener may be applied and dried on a current collector by a method such as bar coating, casting, spraying, or the like to form a first anode mixture layer, and a second anode slurry including a second solvent, a second carbon-based active material, a silicon-based active material, a second binder, and a second conductive material may be applied and dried on the first anode mixture layer by a method such as bar coating, casting, spraying, or the like.

As the solvent, for example, dimethyl sulfoxide (DMSO), isopropyl alcohol, N-methylpyrrolidone (NMP), acetone, water, or the like may be used, and an amount of the solvent to be used is sufficient to dissolve or disperse the active material, the conductive material, and the binder in consideration of a coating thickness and manufacturing yield of a composition for forming an anode mixture layer, and to have a viscosity that may exhibit excellent thickness uniformity when applied to form the anode mixture layer.

### Lithium Secondary Battery

A lithium secondary battery according to an embodiment may include an anode 100 for a lithium secondary battery according to any one of the above-described embodiments. Specifically, the lithium secondary battery may include an anode 100, a cathode, and an electrolyte, for a lithium secondary battery, according to any one of the above-described embodiments, and may or may not further include a separator depending on selection.

The cathode is not particularly limited as long as it may be commonly used in a secondary battery, and may include lithium-transition metal oxide as a cathode active material, and may include for example, lithium-transition metal oxide such as lithium cobalt oxide (LiCoO₂), lithium manganese oxide (LiMn₂O₄), lithium nickel oxide (LiNiO₂), or the like, or lithium-transition metal composite oxide in which some of these transition metals are replaced with other transition metals. Specifically, the cathode active material may be an NCM-based cathode active material represented by the following formula 1; or an LLO (Li rich layered oxide, over-lithiated oxide, over-lithiated layered oxide, OLO, LLOs)-based cathode active material represented by the following formula 2:

LiₐNi_{b}M_{1-b}O₂[Formula 1]

In Formula 1, 0.9≤a≤1.2, b≥0.5, M may be at least one of Na, Mg, Ca, Y, Ti, Hf, V, Nb, Ta, Cr, Mo, W, Mn, Co, Fe, Cu, Ag, Zn, B, Al, Ga, C, Si, Sn, Ba, or Zr.

Specifically, in Formula 1, 0.95≤a≤1.08, and b may be 0.6 or more, 0.8 or more, more than 0.8, 0.9 or more, or 0.98 or more.

Specifically, in Formula 1, M may include Co, Mn, or Al. More specifically, M may include Co and Mn and, depending on selection, may further include Al.

Li₁₊ₓM₁₋ₓO₂[Formula 2]

In Formula 2, 0≤x≤0.4, M may be at least one of Na, Mg, Ca, Y, Ti, Hf, V, Nb, Ta, Cr, Mo, W, Ni, Mn, Co, Fe, Cu, Ag, Zn, B, Al, Ga, C, Si, Sn, Ba, or Zr.

Specifically, in Formula 2, M may include Ni, Co, Mn, or Al, and more specifically, may include Ni, Co, and Mn, and optionally, may further include Al.

Additionally, the cathode active material may be a lithium iron phosphate (LFP)-based cathode active material represented by the formula of LifePO₄.

The lithium secondary battery may be housed together with the electrolyte in a separate case. In this case, the electrolyte may be a liquid electrolyte including a lithium salt and an organic solvent, and the lithium salt may be expressed by the formula of Li⁺X⁻, and, as an anion (X⁻), F⁻, Cl⁻, Br⁻, I⁻, NO₃⁻, N(CN)₂⁻, BF₄⁻, ClO₄⁻, PF₆⁻, or the like may be included in one or two or more types, but are not limited thereto. In addition, the organic solvent may include, but is not limited to, one or two or more types of propylene carbonate (PC), ethylene carbonate (EC), diethyl carbonate (DEC), dimethyl carbonate (DMC), ethylmethyl carbonate (EMC), or the like.

The lithium secondary battery may or may not further include the separator, and when the separator is further included, the separator is not particularly limited as long as it is applicable to a typical lithium secondary battery. Illustratively, the separator may include a porous substrate, and the porous substrate may be a polyolefin-based porous substrate. The polyolefin-based porous substrate may have a large number of pores, and may be a substrate commonly used in electrochemical devices. The polyolefin-based porous substrate may be selected from the group consisting of a polyethylene single film, a polypropylene single film, a polyethylene/polypropylene double film, a polypropylene/polyethylene/polypropylene triple film, and a polyethylene/polypropylene/polyethylene triple film, but is not limited thereto.

When the lithium secondary battery does not further include the separator, the lithium secondary battery may be an all-solid-state battery including a solid electrolyte layer. A solid electrolyte included in the solid electrolyte layer is not particularly limited, and may include at least one common solid electrolyte. Illustratively, the solid electrolyte may be an oxide-based solid electrolyte such as Li₇La₃Zr₂O₁₂ (LLZO) or the like; a sulfide-based solid electrolyte such as thio-LISICON, β-Li₃PS₄, Li₇P₃S₁₁, Li₂S—P₂S₅, LGPS, an argyrodite-based compound, or the like; or a polymer-based solid electrolyte such as (1) a solid polymer electrolyte formed by adding a polymer resin such as a polyether-based polymer or the like to a lithium salt, (2) a polymer gel electrolyte in which a polymer resin is impregnated with an organic electrolyte solution including an organic solvent and a lithium salt.

The lithium secondary battery as described above may have excellent high capacity characteristics, lifespan characteristics, quick charging performance, or the like, and may be very useful as a power source for an electric vehicle (EV), a hybrid electric vehicle (HEV), or the like.

Hereinafter, it is obvious to those skilled in the art that examples will be presented to aid understanding, but these examples are only illustrative and do not limit the scope of the attached claims, and various changes and modifications to the examples are possible within the scope and technical idea, and also fall within the scope of the appended patent claims.

### Inventive Example and Comparative Example

### 1) Preparation of Anode

A first anode slurry was applied and dried on a copper foil to form a first anode mixture layer, and a second anode slurry was applied and dried on the first anode mixture layer to form a second anode mixture layer, to prepare anodes for lithium secondary batteries of Inventive Examples 1 to 3. In addition, an anode for a lithium secondary battery of Comparative Example 1 having the same structure as FIG. 1 was manufactured by forming an anode mixture layer having a single layer structure on a copper foil. Compositions, loading weights (LW), and ratios of the anode mixture layers of Inventive Example and Comparative Example were illustrated in Table 1 below.

In this case, artificial graphite having a unit capacity of 360 mAh/g as a carbon-based active material, silicon oxide (SiOₓ; 0<x<2) having a unit capacity of 1455 mAh/g as a silicon-based active material, a single-walled carbon nanotube (SWCNT) as a linear conductive material, carboxymethylcellulose (CMC) as a water-soluble polymer-based binder, and a styrene-butadiene rubber (SBR) as a rubber-based binder were used.

### 2) Preparation of Secondary Battery

A slurry including an NCM-based active material, which may be a Li-transition metal complex oxide, was applied and dried on an aluminum foil to prepare a cathode, a polyolefin separator was interposed between the cathode and the anode prepared above, and an electrolyte solution in which 1M LiPF₆ is dissolved was injected in a solvent mixed with ethylene carbonate (EC) and diethyl carbonate (DEC), to prepare a lithium secondary battery. The prepared lithium secondary battery was used as a secondary battery sample for Inventive Examples and Comparative Example.

TABLE 1

| | | | Composition (wt %) | | | | | LW (mg/cm²) & Ratio | |
|---|---|---|---|---|---|---|---|---|---|
| | Electrode Structure | | Graphite | SiOₓ | CNT | CMC | SBR | for Each Layer | |
| Comparative | Single Layer | | 91.75 | 5.00 | 0.25 | 1.00 | 2.00 | 12 | (1) |
| Example 1 | | | | | | | | | |
| Inventive | Double | Second Anode | 77.20 | 20.00 | 1.00 | 1.00 | 0.80 | 3 | (0.25) |
| Example 1 | Layer | Mixture Layer | | | | | | | |
| | | (Upper L.) | | | | | | | |
| | | First Anode | 96.60 | — | — | 1.00 | 2.40 | 9 | (0.75) |
| | | Mixture Layer | | | | | | | |
| | | (Lower L.) | | | | | | | |
| | | Total | 91.75 | 5.00 | 0.25 | 1.00 | 2.00 | 12 | (1) |
| Inventive | Double | Second Anode | 92.20 | 5.00 | 1.00 | 1.00 | 0.80 | 3.34 | (0.25) |
| Example 2 | Layer | Mixture Layer | | | | | | | |
| | | (Upper L.) | | | | | | | |
| | | First Anode | 96.60 | — | — | 1.00 | 2.40 | 10.02 | (0.75) |
| | | Mixture Layer | | | | | | | |
| | | (Lower L.) | | | | | | | |
| | | Total | 95.50 | 1.25 | 0.25 | 1.00 | 2.00 | 13.36 | (1) |
| Inventive | Double | Second Anode | 77.20 | 20.00 | 1.00 | 1.00 | 0.80 | 1.31 | (0.1) |
| Example 3 | Layer | Mixture Layer | | | | | | | |
| | | (Upper L.) | | | | | | | |
| | | First Anode | 96.60 | — | — | 1.00 | 2.40 | 11.79 | (0.9) |
| | | Mixture Layer | | | | | | | |
| | | (Lower L.) | | | | | | | |
| | | Total | 94.66 | 2.00 | 0.10 | 1.00 | 2.24 | 13.1 | (1) |

### 3) Calculation of an Upper and Lower Layer Unit Capacity Ratio (R_{uc})

For the anodes of Inventive Examples and Comparative Example, prepared above, a unit capacity ratio (R_{uc}) of each of the layers was calculated according to Equations 1 and 2 and illustrated in Table 2 below:

$${R}_{uc} = {UC}_{2} / {UC}_{1} \qquad [ Equation 1 ]$$

In Equation 1, R_{uc} is an upper and lower layer unit capacity ratio, and UC₁ and UC₂ are unit capacity (UC) of each of the first and second anode mixture layers, respectively, according to Equation 2:

$$UC = ( {W}_{c} \times {C}_{c} ) + ( {W}_{s} \times {C}_{s} ) \qquad [ Equation 2 ]$$

In Equation 2, UC is a unit capacity (mAh/g) in each of the layers, W_{c} and Wₛ are an amount ratio of each of the carbon-based active material and the silicon-based active material in each of the layers, by weight, and C_{c} and Cₛ are a unit capacity (mAh/g) of each of the carbon-based active material and the silicon-based active material.

In this case, the amount ratio (W_{c}) in each of the layers of the carbon-based active material and the amount ratio (Wₛ) in each of the layers of the silicon-based active material may refer to ratio values calculated based on an amount (wt %) of each of the active materials included in the anode mixture layer as 1.

### 4) Upper Electrode Capacity Ratio (R_{ec})

For the anodes of Inventive Examples and Comparative Example, prepared above, an upper electrode capacity ratio (R_{ec}) was calculated according to Equations 3 and 4 and illustrated in Table 2 below:

$${R}_{ec} = {EC}_{2} / ( {EC}_{1} + {EC}_{2} ) \qquad [ Equation 3 ]$$

In Equation 3, R_{ec} is an upper electrode capacity ratio, and EC₁ and EC₂ are an electrode capacity (EC) of each of the first anode mixture layer and the second anode mixture layer according to Equation 4:

$$EC = UC \times {R}_{1 w} \qquad [ Equation 4 ]$$

In Equation 4, EC is an electrode capacity (mAh/g) of each of the layers, UC is a unit capacity (mAh/g) of each of the layers according to Equation 2, and R_{lw} is a loading weight (LW) ratio of each of the layers.

### 5) Evaluation for Quick Charging Lifespan Performance

For the secondary battery samples, a cycle of charging at 2 C in an SOC range of 10 to 80% at 25° C. for 30 minutes and discharging at 1 C was repeated 400 times, and then a discharge capacity maintenance rate relative to initial discharge capacity was measured in %, and results therefrom were illustrated in Table 2.

### 6) Evaluation of Lithium Precipitation During Quick Charging

For the secondary battery samples of Inventive Example 1 and Comparative Example 1, a cycle of charging at 2 C in an SOC range of 10 to 80% at 25° C. for 30 minutes and discharging at 1 C was repeated 100 times, then the secondary battery was disassembled and observation results of a cross-section of the anode were illustrated in FIG. 3.

TABLE 2

| | Upper L. | Lower L. Unit | Upper & | Upper L. | Quick Charging |
|---|---|---|---|---|---|
| | Unit Capacity | Capacity | Lower L. | Electrode | Lifespan |
| | (UC₂; mAh/g) | (UC₁; mAh/g) | Unit Capacity | Capacity | Performance |
| | for Each Layer | for Each Layer | Ratio (R_{uc}) | Ratio (R_{ec}) | (%) |
| Comparative | 403.05 | 403.05 | 1 | 0.5 | 74 |
| Example 1 | | | | | |
| Inventive | 568.92 | 347.76 | 1.636 | 0.353 | 91 |
| Example 1 | | | | | |
| Inventive | 404.67 | 347.76 | 1.164 | 0.279 | 80 |
| Example 2 | | | | | |
| Inventive | 568.92 | 347.76 | 1.636 | 0.154 | 82 |
| Example 3 | | | | | |

Referring to Tables 1 and 2 above, in Inventive Examples 1 to 3, having a double layer structure and including anodes with different compositions of upper and lower layers, it was found that quick charging lifespan performance thereof was superior, as compared to Comparative Example 1 including an anode having a single layer structure and the same composition without distinction between the upper and lower layers. Additionally, referring to FIG. 3, in Inventive Example 1, unlike Comparative Example 1, it was found that lithium precipitation (plating) did not substantially occur on a surface of the anode after quick charging.

The above results indicate that, when the silicon-based active material having a high volume expansion rate is not substantially included in the first anode mixture layer (lower layer) adjacent to the current collector, and the second anode mixture layer (upper layer) spaced away from the current collector and adjacent to the anode surface is included, it is believed that this is because influence of volume expansion of the silicon-based active material is suppressed more efficiently and high capacity characteristics is secured.

In particular, in Inventive Example 1, since the silicon-based active material was included in a high amount of 10 wt % or more in the second anode mixture layer (upper layer) and a loading weight of the second anode mixture layer was appropriately controlled, it was also found that the electrode as a whole had a larger amount of the silicon-based active material, as compared to Inventive Examples 2 and 3, and quick charging lifespan performance was very excellent.

Considering the above results, when an amount of the silicon-based active material, a type of conductive material, or the like in the upper and lower layers are applied differently, and a loading weight of the upper and lower layers is also appropriately adjusted, in an anode having a multilayer structure including a silicon-based active material, it can be believed that an anode having excellent capacity as a whole, quick charging characteristics, or the like, and a secondary battery including the same may be provided.

According to an embodiment, problems caused by volume expansion of a silicon-based active material included in an anode for a lithium secondary battery may be alleviated.

According to another embodiment, an anode for a high-capacity lithium secondary battery having excellent lifespan characteristics may be provided.

According to another embodiment, a precipitation phenomenon of lithium metal may be alleviated during quick charging of a lithium secondary battery.

According to another embodiment, an amount of an expensive conductive material may be reduced to improve economic efficiency when manufacturing a secondary battery.

Only specific examples of implementations of certain embodiments may be described. Variations, improvements and enhancements of the disclosed embodiments and other embodiments may be made based on the disclosure of this patent document.

What is claimed is:

1. An anode for a lithium secondary battery, comprising:
a current collector;
a first anode mixture layer on at least one surface of the current collector; and
a second anode mixture layer on the first anode mixture layer,
wherein the first anode mixture layer and the second anode mixture layer include a carbon-based active material, respectively,
the second anode mixture layer includes a silicon-based active material, and
in the anode, an upper and lower layer unit capacity ratio (R_{uc}) according to Equation 1 is 1.1 or more:
$${R}_{uc} = {UC}_{2} / {UC}_{1} \qquad [ Equation 1 ]$$
where R_{uc} is an upper and lower layer unit capacity ratio, and UC₁ and UC₂ are unit capacity (UC) of each of the first and second anode mixture layers, respectively, according to Equation 2:
$$UC = ( {W}_{c} \times {C}_{c} ) + ( {W}_{s} \times {C}_{s} ) \qquad [ Equation 2 ]$$
where UC is a unit capacity (mAh/g) in each of the layers, W_{c} and Wₛ are an amount ratio of each of the carbon-based active material and the silicon-based active material in each of the layers, by weight, and C_{c} and Cₛ are a unit capacity (mAh/g) of each of the carbon-based active material and the silicon-based active material.

2. The anode of claim 1, wherein an upper electrode capacity ratio (R_{ec}) according to Equation 3 is less than 0.5:
$${R}_{ec} = {EC}_{2} / ( {EC}_{1} + {EC}_{2} ) \qquad [ Equation 3 ]$$
where R_{ec} is an upper electrode capacity ratio, and EC₁ and EC₂ are an electrode capacity (EC) of each of the first anode mixture layer and the second anode mixture layer according to Equation 4:
$$EC = UC \times {R}_{1 w} \qquad [ Equation 4 ]$$
where EC is an electrode capacity (mAh/g) of each of the layers, UC is a unit capacity (mAh/g) of each of the layers according to Equation 2, and R_{lw} is a loading weight (LW) ratio of each of the layers.

3. The anode of claim 1, wherein an amount of the silicon-based active material in the second anode mixture layer is 10 wt % or more, based on a total weight of the second anode mixture layer.

4. The anode of claim 1, wherein the second anode mixture layer further comprises a linear conductive material.

5. The anode of claim 4, wherein the linear conductive material is any one selected from a single-walled carbon nanotube (SWCNT), a multi-walled carbon nanotube (MWCNT), and combinations thereof.

6. The anode of claim 1, wherein a loading weight (LW) ratio of the first anode mixture layer and the second anode mixture layer is 1.1:1 to 5:1.

7. The anode of claim 1, wherein the first anode mixture layer and the second anode mixture layer further comprise a binder and a thickener, respectively,
wherein, in the first anode mixture layer, an amount of the binder by weight is higher than an amount of the thickener by weight, and
wherein, in the second anode mixture layer, an amount of the binder by weight is lower than an amount of the thickener by weight.

8. The anode of claim 7, wherein the binder comprises a rubber-based compound, and
the thickener comprises a water-soluble polymer-based compound.

9. A lithium secondary battery comprising the anode of claim 1.
